(19) United States
(12) Patent Application Publication
(10) Pub. No.: US 2026/0301297 A1
(43) Pub. Date: Oct. 1, 2026

(54) MERGED SHADER VERTEX REUSE

(71) Applicant: QUALCOMM Incorporated, San Diego, CA (US)

(72) Inventors: Vishwanath Shashikant NIKAM, Bangalore (IN); Kalyan Kumar BHIRAVABHATLA, Bengaluru (IN); Yun DU, San Diego, CA (US); John Alan L. RAPP, Florianopolis (BR); Zilin YING, San Diego, CA (US)

(21) Appl. No.: 19/090,155

(22) Filed: Mar. 25, 2025

(51) Int. Cl. G06T 15/00; G06T 17/20

(52) U.S. Cl. CPC G06T 15/005; G06T 17/20

(57) ABSTRACT

This disclosure provides systems, devices, apparatus, and methods, including computer programs encoded on storage media, for merged shader vertex reuse. A graphics processor may obtain an input mesh comprising a set of vertices and a set of primitives, wherein each primitive of the set of primitives is associated with a corresponding subset of the set of vertices. The graphics processor may process the set of vertices. The graphics processor may store the processed set of vertices based on a set of memory addresses. The graphics processor may generate a primitive connectivity table that associates each primitive of the set of primitives with a corresponding subset of the set of memory addresses based on the corresponding subset of the set of vertices. The graphics processor may process the set of primitives based on the primitive connectivity table.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address memory resource inefficiencies in merged shaders. There is a need for improved memory resource techniques for merged shaders.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and at least one processor coupled to the memory and, based at least in part on information stored in the memory, the at least one processor may be configured to: obtain an input mesh comprising a set of vertices and a set of primitives, wherein each primitive of the set of primitives is associated with a corresponding subset of the set of vertices. The at least one processor may be configured to process the set of vertices. The at least one processor may be configured to store the processed set of vertices based on a set of memory addresses. The at least one processor may be configured to generate a primitive connectivity table that associates each primitive of the set of primitives with a corresponding subset of the set of memory addresses based on the corresponding subset of the set of vertices. The at least one processor may be configured to process the set of primitives based on the primitive connectivity table.

In some aspects, the techniques described herein relate to a method of graphics processing, including: obtaining an input mesh including a set of vertices and a set of primitives, where each primitive of the set of primitives is associated with a corresponding subset of the set of vertices; processing the set of vertices; storing the processed set of vertices based on a set of memory addresses; generating a primitive connectivity table that associates each primitive of the set of primitives with a corresponding subset of the set of memory addresses based on the corresponding subset of the set of vertices; and processing the set of primitives based on the primitive connectivity table.

In some aspects, the techniques described herein relate to a method, further including: storing the processed set of primitives to memory; or outputting the processed set of primitives.

In some aspects, the techniques described herein relate to a method, where processing the set of vertices and processing the set of primitives includes: processing the set of vertices and the set of primitives via a merged geometry processing shader.

In some aspects, the techniques described herein relate to a method, where the merged geometry processing shader includes at least one of: a merged vertex shader (VS) and hull shader (HS); or a merged domain shader (DS) and geometry shader (GS).

In some aspects, the techniques described herein relate to a method, where processing the set of vertices includes: refraining from processing any vertex of the set of vertices twice.

In some aspects, the techniques described herein relate to a method, where refraining from processing any vertex of the set of vertices twice includes: refraining from processing any vertex of the set of vertices twice based on a vertex reuse cache in an input assembler stage.

In some aspects, the techniques described herein relate to a method, where obtaining the input mesh includes: obtaining the input mesh from an input assembler stage.

In some aspects, the techniques described herein relate to a method, further including: obtaining a set of vertex offsets from the input assembler stage; and determining the set of memory addresses based on the obtained set of vertex offsets.

In some aspects, the techniques described herein relate to a method, where processing the set of vertices includes: distributing a plurality of subsets of the set of vertices among a plurality of threads, where no subset of the plurality of subsets of the set of vertices overlap with one another; and parallelly executing a plurality of vertex processing threads, where each vertex processing thread of the plurality of vertex processing threads processes a subset of the plurality of subsets of the set of vertices.

In some aspects, the techniques described herein relate to a method, where processing the set of primitives includes: distributing a plurality of subsets of the set of primitives among a plurality of threads, where no subset of the plurality of subsets of the set of primitives overlap with one another; and parallelly executing a plurality of primitive processing threads, where each primitive processing thread of the plurality of primitive processing threads processes a subset of the plurality of subsets of the set of primitives.

In some aspects, the techniques described herein relate to a method, further including: synchronizing each primitive processing thread with a subset of the plurality of vertex processing threads based on the primitive connectivity table.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4 illustrates an example GPU pipeline, in accordance with one or more techniques of this disclosure.

FIG. 5 illustrates another example GPU pipeline, in accordance with one or more techniques of this disclosure.

FIG. 6A illustrates an example input mesh, in accordance with one or more techniques of this disclosure.

FIG. 6B illustrates an example primitive connectivity table, in accordance with one or more techniques of this disclosure.

FIG. 6C illustrate an example merged shader thread group and on-chip storage, in accordance with one or more techniques of this disclosure.

FIG. 7 is a call flow diagram illustrating example communications between a CPU and a GPU in accordance with one or more techniques of this disclosure.

FIG. 8 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some aspects, a graphics processor unit (GPU) architecture may have a plurality of operational stages in a pipeline. The pipeline may include a number of stages, such as fixed function stages and programmable stages. The fixed function stages may include hardware implemented to perform a set of defined functions in response to receiving a set of inputs. In other words, the fixed function stages may have hardware blocks that perform functions that are not programmable. The fixed function stages may include at least one of an input assembler, a tessellator, a rasterizer, or an output stage. The programmable stages may include user-defined shaders that are executed on shader processor hardware. In other words, the programmable stages may have functions that may be changed by a software update (e.g., a firmware update). The programmable stages may include at least one of a vertex shader (VS), a hull shader (HS), a domain shader (DS), a geometry shader (GS), or a fragment shader (FS). The stages of the pipeline may access shared memory resources, such as index buffers, attribute buffers, constant buffers, and texture buffers. The memory resources may be referred to as on-chip memory, or graphics memory (GMEM).

In some examples, a graphics processor (or graphics processor system) may obtain an input mesh. An input mesh may be a representation of a set of primitives to be drawn by a GPU pipeline. Each primitive of the set of primitives may be associated with a set of vertices. The input mesh may include an indication of the set of primitives and an indication of which vertices are associated with each primitive of the set of primitives. In other words, each primitive of the set of primitives may be associated with a corresponding subset of the set of vertices. In some aspects, two primitives may share at least one vertex of the set of vertices. The graphics processor may process the set of vertices. For example, the graphics processor may perform lightening on a vertex or may transform the vertex. The graphics processor may storing the processed set of vertices based on a set of memory addresses. The graphics processor may generate a primitive connectivity table that associates each primitive of the set of primitives with a corresponding subset of the set of memory addresses based on the corresponding subset of the set of vertices. As used herein, a primitive connectivity table may be any type of one or more data structures used to store data in an associative manner and may include an indication of each primitive of the set of primitives. The primitive connectivity table may associate each primitive of the set of primitives with a corresponding subset of the set of memory addresses. The primitive connectivity table may include an indication of each of the set of memory addresses. In some aspects, the primitive connectivity table may be used to determine the memory addresses of each processed vertex associated with any primitive of the set of primitives. The graphics processor may process the set of primitives based on the primitive connectivity table. For example, the graphics processor may draw the primitive by retrieving the corresponding processed vertices associated with the primitive.

The graphics processor may store the processed set of primitives to a memory. For example, the graphics processor may store the processed set of primitives to GMEM or to a system memory. The graphics processor may output the processed set of primitives. For example, the graphics processor may output the processed set of primitives to a display or a display processing unit (DPU). To process the set of vertices and processing the set of primitives, the graphics processor may process the set of vertices and the set of primitives via a merged geometry processing shader. A merged geometry processing shader may be a shader that merges the functionality of a vertex processing shader and a primitive processing shader. In some aspects, a merged geometry processing shader may process a vertex and a primitive. In some aspects, the merged geometry processing shader may process a set of vertices and may process a set of primitives based on the associated vertices processed by the merged geometry processing shader. A merged geometry processing shader may merge the functionality of a vertex shader (VS) and a hull shader (HS). In other words, the merged geometry processing shader may include a VS and an HS. A merged geometry processing shader may merge the functionality of a domain shader (DS) and a geometry shader (GS). In other words, the merged geometry processing shader may include a DS and a GS. To process the set of vertices, the graphics processor may refrain from processing any vertex of the set of vertices twice. In other words, the graphics processor may be configured to ensure that each vertex is processed independently. This enables reuse of vertices across multiple primitives by processing unique vertices. To refrain from processing any vertex of the set of vertices twice, the graphics processor may refrain from processing any vertex of the set of vertices twice based on a vertex reuse cache in an input assembler. A vertex reuse cache may be a memory used by a shader (e.g., a geometry processing shader) that is used to store a processed vertex. For example, the graphics processor may keep track of each vertex processed within a vertex reuse cache, and check against the vertex reuse cache when processing a vertex to ensure that the graphics processor does not process the same vertex twice. An input assembler may obtain a set of inputs, for example primitive data from user-filled buffers, and assemble the data into objects that are used by the GPU pipeline stages. The input assembler may assemble primitive data into an input mesh of vertices and associated primitives that contextualize the topology of an index buffer. The input assembler may be a fixed function stage, which includes hardware implemented to assemble the primitive data to the input mesh of vertices and associated primitives. A fixed function input assembler may have non-programmable hardware blocks that are configured to generate the input mesh of vertices and associated primitives. The input assembler may also have a set of hardware blocks that provide a set of vertex offsets used to select memory addresses to store processed vertex data on, and provide vertex reuse cache data for merged geometry processing shaders. To obtain the input mesh, the graphics processor may obtain the input mesh from an input assembler. The graphics processor may obtain a set of vertex offsets from the input assembler. The graphics processor may determine the set of memory addresses based on the obtained set of vertex offsets. The set of vertex offsets may indicate memory address offsets that may be used to store processed vertex data in a memory location, such as on-chip memory or GMEM. To process the set of vertices, the graphics processor may distribute a plurality of subsets of the set of vertices among a plurality of threads and parallelly execute a plurality of vertex processing threads. No subset of the plurality of subsets of the set of vertices may overlap with one another. In other words, each vertex may be unique. Each vertex processing thread of the plurality of vertex processing threads may process a subset of the plurality of subsets of the set of vertices. To process the set of primitives, the graphics processor may distribute a plurality of subsets of the set of primitives among a plurality of threads and parallelly execute a plurality of primitive processing threads. No subset of the plurality of subsets of the set of primitives may overlap with one another. In other words, each primitive may be unique. Each primitive processing thread of the plurality of primitive processing threads may process a subset of the plurality of subsets of the set of primitives. The graphics processor may synchronize each primitive processing thread with a subset of the plurality of vertex processing threads based on the primitive connectivity table. For example, the graphics processor may synchronize each primitive processing thread with a plurality of associated vertex processing threads, ensuring that the primitive processing thread moves forward with processing after the associated vertex processing threads first process the vertices corresponding with the primitive of the primitive processing thread.

In some aspects, a graphics processor may have an architecture that reduces shader processor workload for merged shader execution by enabling vertex reuse. The graphics processor may implement thread-group execution with on-chip shared memory, where the on-chip shared memory acts as a reuse cache within a corresponding thread group.

Particular aspects of the subject matter described in this disclosure can be implemented to realize one or more of the following potential advantages. In some examples, by synchronizing primitives and vertices using a primitive connectivity table, the described techniques can be used to ensure that merged geometry processing shaders process unique vertices within a thread group.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

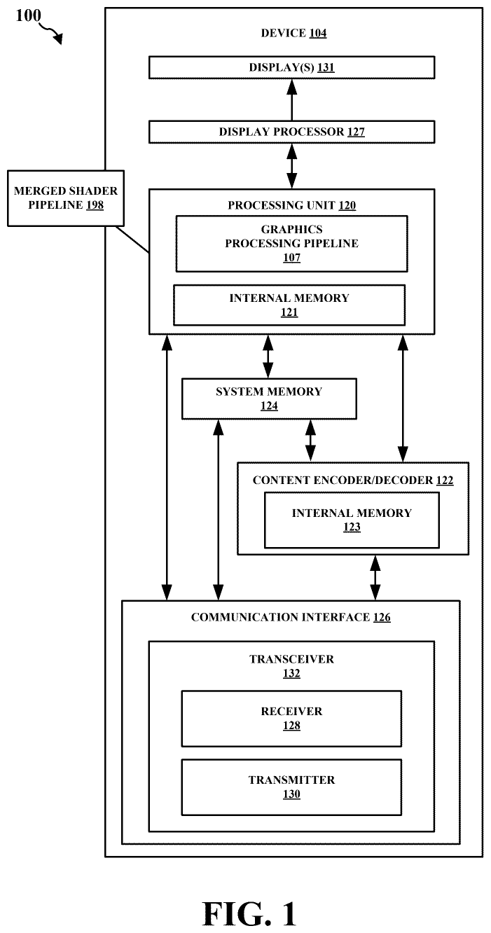

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors. A set of processors configured to perform a set of tasks may be configured to perform the set of tasks individually, or in any combination.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a merged shader pipeline 198 configured to obtain an input mesh comprising a set of vertices and a set of primitives. Each primitive of the set of primitives may be associated with a corresponding subset of the set of vertices. The merged shader pipeline 198 may be configured to process the set of vertices. The merged shader pipeline 198 may be configured to store the processed set of vertices based on a set of memory addresses. The merged shader pipeline 198 may be configured to generate a primitive connectivity table that associates each primitive of the set of primitives with a corresponding subset of the set of memory addresses based on the corresponding subset of the set of vertices. The merged shader pipeline 198 may be configured to process the set of primitives based on the primitive connectivity table. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

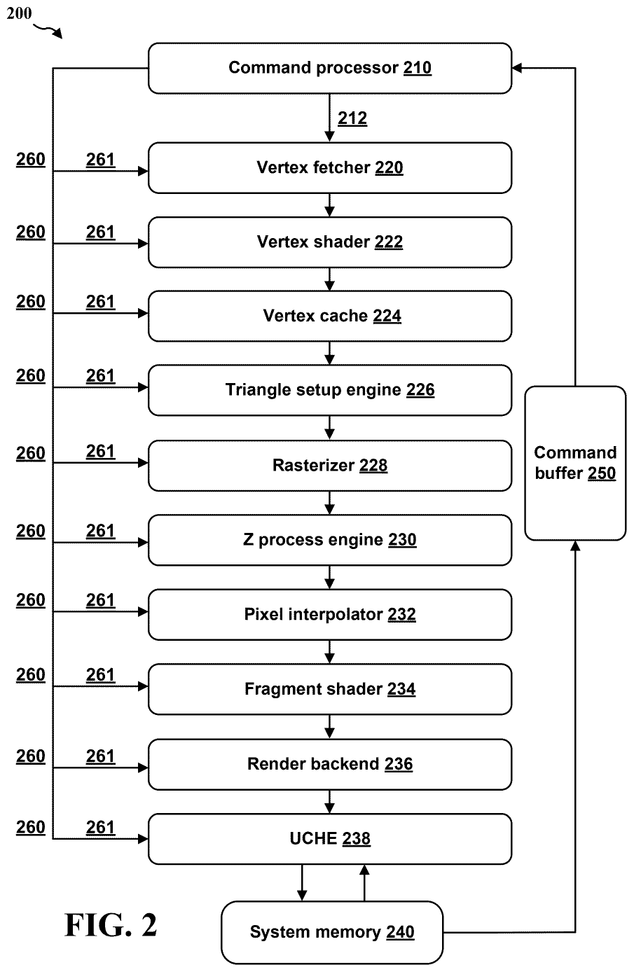

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

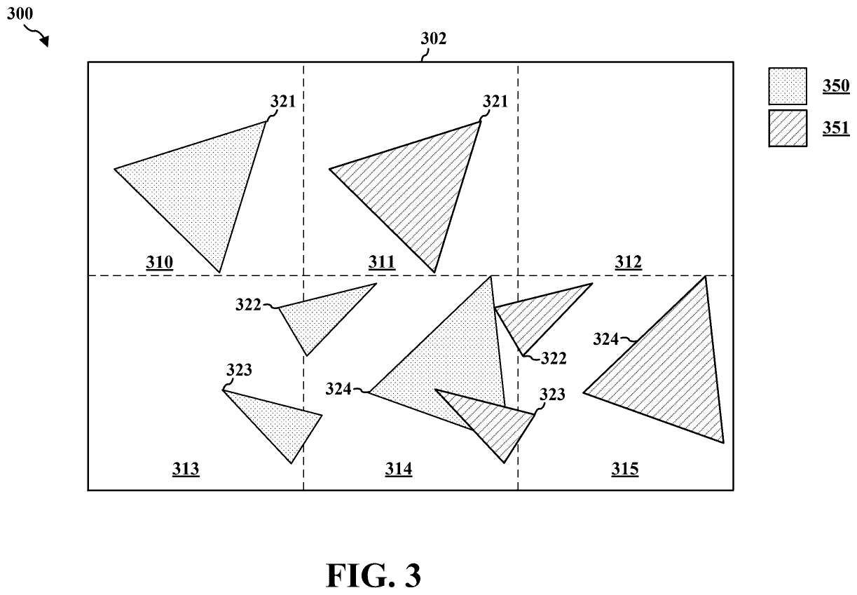

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

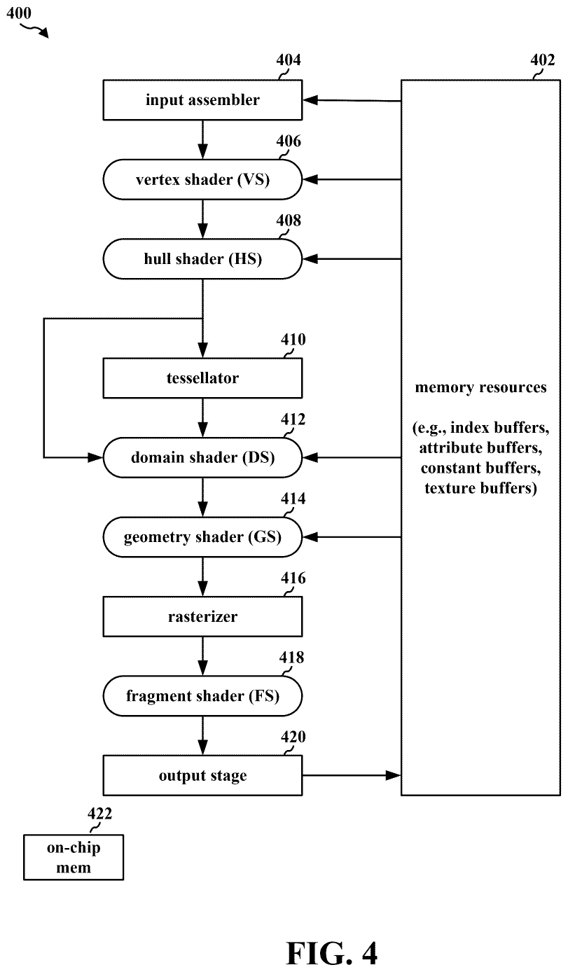

FIG. 4 illustrates a GPU pipeline 400, in accordance with one or more techniques of this disclosure. The GPU pipeline 400 may include various operational stages, shown here as an input assembler 404, a vertex shader (VS) 406, a hull shader (HS) 408, a tessellator 410, a domain shader (DS) 412, a geometry shader (GS) 414, a rasterizer 416, a fragment shader (FS) 418, and an output stage 420. As shown, the outputs of a shader stage may be used by another shader stage. For example, the outputs of the VS 406 may be used by the HS 408. Each stage may read memory shader resources from the memory resources 402 relevant to the stage. For example, the VS 406 may read memory shader resources from the memory resources 402 relevant to the VS 406. The memory resources 402 may be system memory accessible by the GPU pipeline 400, for example double data rate (DDR) memory, also referred to as off-chip memory. The stages of the GPU pipeline 400 may also store data to, and fetch data from, on-chip memory 422, which may also be referred to as graphics memory (GMEM) or dedicated memory for the GPU. The GPU may be configured to allocate dedicated memory addresses for each operational stage of the GPU pipeline 400 to the on-chip memory 422, such that one operational stage of the GPU pipeline 400 is not configured to access memory addresses allocated to another operational stage of the GPU pipeline 400.

The GPU pipeline 400 may have fixed function stages, illustrated as rectangular stages, and programmable stages, illustrated as oval-shaped stages, or as stages with rounded corners. A fixed function stage may be a hardware-implemented stage that performs a well-defined function. The fixed function stage may not be programmable, as hardware blocks may be specifically designed to perform the various fixed functions of the fixed function stage. A programmable shader stage may include user-defined shaders that run on shader processor hardware, such as a GPU processor. The function of a programmable shader stage may be updated by a firmware update. The input assembler 404, the tessellator 410, the rasterizer 416, and the output stage 420 may be fixed function stages of the GPU pipeline 400. The VS 406, the HS 408, the DS 412, the GS 414, and the FS 418 may be programmable shader stages of the GPU pipeline 400.

The programmable shader stages may be optionally enabled. The VS 406, the HS 408, the DS 412, and the GS 414 may also be referred to as geometry processing shaders, as they process the geometry of a primitive (e.g., transformations of a vertex and a primitive). The FS 418 may also be referred to as a pixel processing shader (e.g., a texture of a primitive). The VS 406 and the DS 412 may also be referred to as vertex processing shaders, as they obtain a set of vertices as inputs from the memory resources 402. The VS 406 and the GS 414 may process vertices independently. This enables reuse of vertices across multiple primitives by processing unique vertices. The VS 406 and the GS 414 may ensure that they process unique vertices by using a vertex re-use cache. A vertex processing shader that uses a vertex re-use cache may reduce its vertex processing workload by ensuring each vertex processed is unique. The HS 408 and the GS 414 may also be referred to as primitive processing shaders, as they obtain a set of primitives as inputs from the memory resources 402. The primitive processing shaders may use all vertices of each primitive as an input. Vertex shaders that have vertex re-use caches may reuse vertices as inputs to the primitive processing shaders.

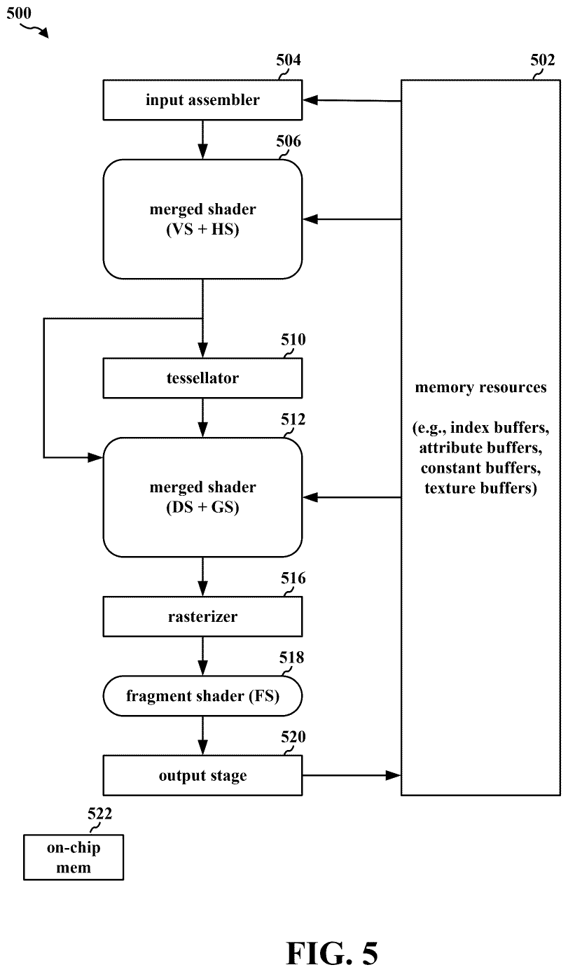

FIG. 5 illustrates a GPU pipeline 500, in accordance with one or more techniques of this disclosure. When more than one geometry processing shaders are enabled, a GPU pipeline, such as the GPU pipeline 500 in FIG. 5, may merge consecutive shader stages. For example, a compiler may programmatically support a smaller number of shader stages to save area by executing two consecutive shaders as a single shader. A merged shader may use less resources than two unmerged shaders, as the merged shader may use the same memory resources within the processor and may share variables between the vertex processing shader and the primitive processing shader. As shown, the GPU pipeline 500 may have a merged shader 506 which merges a VS and an HS. As shown, the GPU pipeline 500 may have a merged shader 512 which merges a DS and a GS. The merged shaders may be executed on the shader processor hardware of a GPU. Each stage may read memory shader resources from the memory resources 502 relevant to the stage. For example, the merged shader 506 may read memory shader resources from the memory resources 502 relevant to the merged shader 506. The memory resources 502 may be system memory accessible by the GPU pipeline 500, for example DDR memory, also referred to as off-chip memory. The stages of the GPU pipeline 500 may also store data to, and fetch data from, on-chip memory 522, which may also be referred to as graphics memory (GMEM) or dedicated memory for the GPU. The GPU may be configured to allocate dedicated memory addresses for each operational stage of the GPU pipeline 500 to the on-chip memory 522, such that one operational stage of the GPU pipeline 500 is not configured to access memory addresses allocated to another operational stage of the GPU pipeline 500.

The GPU pipeline 500 may also include various operational stages, shown here as an input assembler 504, a tessellator 510, a rasterizer 516, a fragment shader (FS) 518, and an output stage 520. Similarly to FIG. 4, the GPU pipeline 500 may have fixed function stages, illustrated as rectangular stages, and programmable stages, illustrated as oval-shaped stages, or as stages with rounded corners. The input assembler 504, the tessellator 510, the rasterizer 516, and the output stage 520 may be fixed function stages of the GPU pipeline 500. The merged shader 506, the merged shader 512, and the FS 518 may be programmable shader stages of the GPU pipeline 500.

A merged shader may have a primitive processing shader. For example, the merged shader 506 may have an HS and the merged shader 512 may have a GS. However, as primitive processing shaders use all vertices of primitives as an input, a merged shader may not have a vertex reuse cache. In other words, the GPU pipeline 500 may disable the vertex reuse cache for merged shader 506 for merged shader execution, and/or the GPU pipeline 500 may disable the vertex reuse cache for merged shader 512 for merged shader execution. This may result in a higher shader processor workload for merged shaders.

In some aspects, the input assembler 504 may be configured to enable vertex reuse by constructing an input mesh for the merged shader that allows a merged shader to track vertices of primitives. For example, the input assembler 504 may output a generated input mesh for the merged shader 506, which may then output a processed input shader to the merged shader 512.

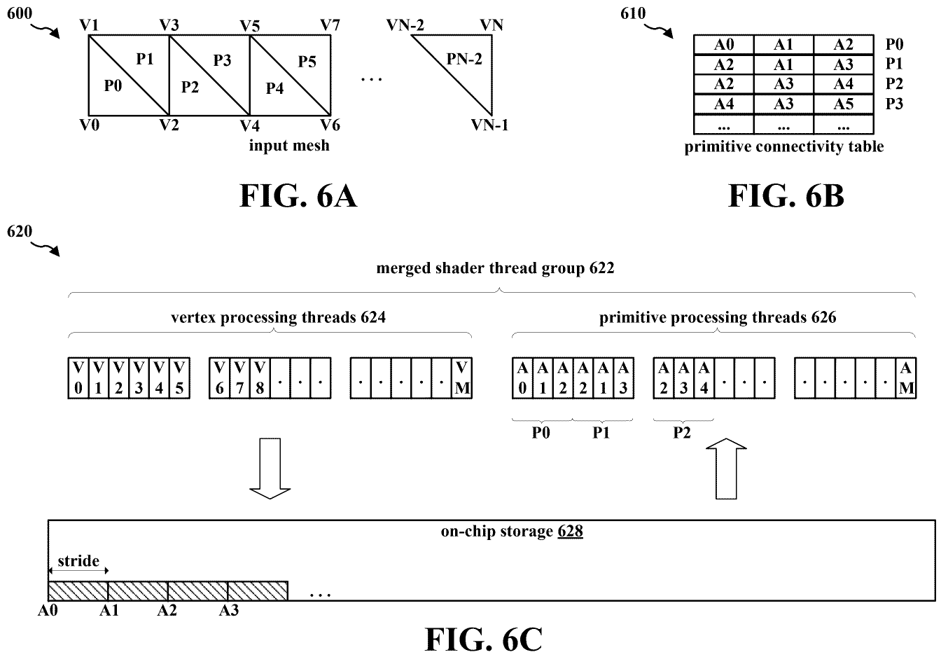

FIG. 6A illustrates an input mesh 600, in accordance with one or more techniques of this disclosure. The input mesh 600 may be a representation of relationships between primaries and vertices. As shown in FIG. 6A, primitive P0 may have vertices V0, V1, and V2, while primitive P1 has vertices V1, V2, and V3. Primitive P0 and primitive P1 may share the vertices V1 and V2. Primitive P1 may have vertices V1, V2, and V3, while primitive P2 has vertices V2, V3, and V4. Primitive P1 and primitive P2 may share the vertices V2 and V3. Primitive P2 may have vertices V2, V3, and V4, while primitive P3 has vertices V3, V4, and V5. Primitive P2 and primitive P3 may share the vertices V3 and V4. Primitive P3 may have vertices V3, V4, and V5, while primitive P4 has vertices V4, V5, and V6. Primitive P3 and primitive P4 may share the vertices V4 and V5. Primitive P4 may have vertices V4, V5, and V6, while primitive P4 has vertices V5, V6, and V7. Primitive P4 and primitive P5 may share the vertices V5 and V6. While the primaries shown in the input mesh 600 each share two vertices with adjacent primaries, a primitive may share one, or zero vertices with adjacent primaries in other aspects.

An input assembler 504 may generate an input mesh based on a set of instructions from a CP, for example a set of instructions to draw a set of primaries. The input assembler 504 may provide the input mesh to the merged shader 506 and/or the merged shader 512 for generating a primitive connectivity table. The primitive connectivity table may be used to correlate a primitive with a set of memory addresses associated with processed vertices. In some aspects, the input assembler 504 may also generate an indication of a set of memory address offsets that may be used by a merged shader to construct a primitive connectivity table. For example, the input assembler 504 may determine that an input mesh has a number of unique vertices M, and may then provide M memory address offsets to the merged shader for constructing a primitive connectivity table. In another example, the input assembler may determine that an input mesh has a number of unique vertices M, and may then provide the number M to the merged shader for generating a primitive connectivity table having M unique memory addresses for the vertices of the input mesh.

FIG. 6B illustrates a primitive connectivity table 610, in accordance with one or more techniques of this disclosure. The primitive connectivity table 610 may correlate each row with a set of memory addresses that are associated with the corresponding primitive of that row. The primitive connectivity table 610 may store vertex offsets, of vertex addresses, for each vertex of a primitive. The entries may include hit vertex offsets (e.g., reused vertices) and missed vertex offsets. The vertex offsets may be relative to a workgroup shader, and may be reset, or be associated with an invalidity flag, at the end of each workgroup. Here, the merged shader may generate the primitive connectivity table 610 based on the input mesh 600, correlating memory addresses associated with processed vertices with corresponding primaries. For example, the primitive connectivity table 610 may associate the primitive P0 with the memory addresses A0, A1, and A2, which are associated with the vertices V0, V1, and V2, respectively. The vertex processing shader may store the processed vertices V0, V1, and V2 in the memory addresses A0, A1, and A2, respectively. Similarly, the primitive connectivity table 610 may associate the primitive P1 with the memory addresses A1, A2, and A3, which are associated with the vertices V1, V2, and V3, respectively. The vertex processing shader may store the processed vertices V1, V2, and V3 in the memory addresses A1, A2, and A3, respectively. Similarly, the primitive connectivity table 610 may associate the primitive P2 with the memory addresses A2, A3, and A4, which are associated with the vertices V2, V3, and V4, respectively. The vertex processing shader may store the processed vertices V2, V3, and V4 in the memory addresses A2, A3, and A4, respectively. Similarly, the primitive connectivity table 610 may associate the primitive P3 with the memory addresses A3, A4, and A5, which are associated with the vertices V3, V4, and V5, respectively. The vertex processing shader may store the processed vertices V3, V4, and V5 in the memory addresses A3, A4, and A5, respectively.

In order to enable vertex reuse for a merged shader, a GPU pipeline may conduct thread-group execution with an on-chip storage, which may act as a reuse cache within a thread group.

FIG. 6C is a drawing 620 that illustrates a merged shader thread group 622, in accordance with one or more techniques of this disclosure. A thread group may include multiple threads, where each thread has multiple fibers processed concurrently in a single instruction multiple data (SIMD) manner, ensuring that the same, or similar, instruction executing on the multiple threads are aligned. A merged shader thread group may have different types of threads. For example, vertex processing threads may be configured to process unique vertices within a thread group. In contrast, primitive processing threads may process all primitives of the thread group, even if two primitives may use the same vertex.

The merged shader thread group 622 may have a set of vertex processing threads 624 and a set of primitive processing threads 626. Each vertex processing thread may process a unique vertex of an input mesh, such as the input mesh 600 in FIG. 6A. The set of vertex processing threads 624 may store each processed vertex to a corresponding memory address on the on-chip storage 628. As shown, each vertex processing thread may process six unique vertices. The on-chip storage 628 may store each processed vertex in a stride of memory. The set of primitive processing threads 626 may read processed vertices from corresponding memory addresses from the on-chip storage 628. As shown, each primitive processing thread may process six memory addresses, which may or may not be unique the thread. The merged shader thread group 622 may synchronize each primitive processing thread of the set of primitive processing threads 626 with a subset of the set of vertex processing threads 624. For example, the set of primitive processing threads for P0 may be synchronized with the set of vertex processing threads for V0, V1, and V2, to ensure that the primitive processing threads read from the memory addresses after the corresponding vertex has been processed and stored in the corresponding memory address. In another example, the set of primitive processing threads for P1 may be synchronized with the set of vertex processing threads for V1, V2, and V3, to ensure that the primitive processing threads read from the memory addresses after the corresponding vertex has been processed and stored in the corresponding memory address.

A merged shader pipeline may be configured to limit the size of a thread group by a capacity of the on-chip storage 628 per shader processor, or by the size of the primitive connectivity table 610 in the input assembler. For example, each stride may be configured to be large enough to store all vertex outputs from a single vertex processor shader (e.g., all 6 vertex outputs from the first vertex processing thread that processes vertices V0 to V5). If the on-chip storage 628 is large enough to hold a maximum of 100 strides, then the merged shader pipeline may be configured to limit the size of a thread group to 100 strides, or 600 unique vertices, which may be processed simultaneously. However, if the 600 vertices correspond to 30 primitives (e.g., 20 vertices per primitive), and the primitive connectivity table 610 is configured to hold a maximum of 15 primitives, then the merged shader pipeline may limit the size of the thread group to 50 strides, which correlates with 15 primitives×20 vertices per primitive=300 vertices. The merged shader pipeline may select the number of maximum threads per thread group based on a primitive boundary such that the on-chip storage can hold all unique vertex outputs of all vertices in the vertex processing thread group, or based on a primitive boundary such that the primitive connectivity table can hold all primitives of all primitives in the primitive processing thread group. In other words, the merged shader pipeline may select a maximum number of threads per thread group based on the size of the on-chip storage, and/or based on the size of the primitive connectivity table—whichever size is more limiting. This ensures that each thread group may execute independently on any shader processor.

The merged shader pipeline may be configured to ensure that the vertex processing threads 624 processes unique vertices be leveraging the vertex reuse cache in an input assembler stage, such as the input assembler 504 in FIG. 5. The input assembler may manage addressing for the on-chip storage 628 for inter-thread communications. For example, the input assembler may populate the primitive connectivity table 610 with addresses that stitch the vertex processing threads 624 with the primitive processing threads 626 using a thread sync, such that each primitive processing thread fetches data from an address of the on-chip storage 628 after the correlated vertex processing thread stores the processed vertex to the corresponding address. The input assembler may leverage the amount of vertex processing shader output data for each vertex to calculate each vertex address offset of on-chip inter-thread communication storage where the vertex processing shader output is stored for each vertex. In other words, the amount of vertex processing shader output data for each vertex may be used to define the size of each vertex stride and calculate the stride used for storing all processed vertices of a vertex processing thread. The vertex offsets may be used to calculate the addresses for each vertex.

An input assembler, such as the input assembler 504 in FIG. 5, may be configured to dispatch both the vertex processing threads 624 and the primitive processing threads 626 of the merged shader thread group 622. The input assembler may pack missed vertices in its reuse cache into threads and dispatch the packed threads to the shader processor. The input assembler may determine the number of vertices in one thread based on a number of execution units in the shader processor. For example, a shader processor with six execution units may be assigned a thread configured to process six vertices. For each vertex along with its associated input attributes, the input assembler may send a vertex offset (e.g., A*) as part of the thread payload. The input assembler may stop vertex processing threads of a thread group at the primitive boundary in response to either the primitive connectivity table 610 reaching capacity, or the on-chip storage 628 reaching capacity. The input assembler may dispatch the primitive processing threads 626 after dispatching the vertex processing threads 624, as the primitive processing threads are dependent upon outputs from the vertex processing threads. The primitive processing threads 626 may include vertex offsets for each vertex of a primitive in accordance with the entries in the primitive connectivity table 610. The primitive processing threads 626 may terminate upon dispatching all primitives from the primitive connectivity table 610. Each thread group may have multiple threads, where the threads end at the primitive boundary in response to either the primitive connectivity table 610 reaching capacity, or the on-chip storage 628 reaching capacity.

The merged shader pipeline may execute the threads of the vertex processing threads 624 to produce output that is stored on the on-chip storage 628. The merged shader pipeline may store each vertex output on the on-chip storage 628, which acts as an inter-thread communication storage at locations specified by the vertex offsets provided along with the thread payload. The merged shader pipeline may commence execution of the threads of the primitive processing threads 626, which may then read the vertex outputs using the vertex offsets of each vertex of the corresponding primitive provided in the thread payload. Since the merged shader pipeline processes unique vertices, the shader processor workload is reduced compared with merged shaders that do not use a primitive connectivity table to prevent the same vertex from being processed by a vertex shader multiple times. Such merged shader may be used in both geometry processing and pixel processing to reduce the shader processor workload by executing the shaders as a thread group and by using position-based visibility of the primitive to synchronize the threads.

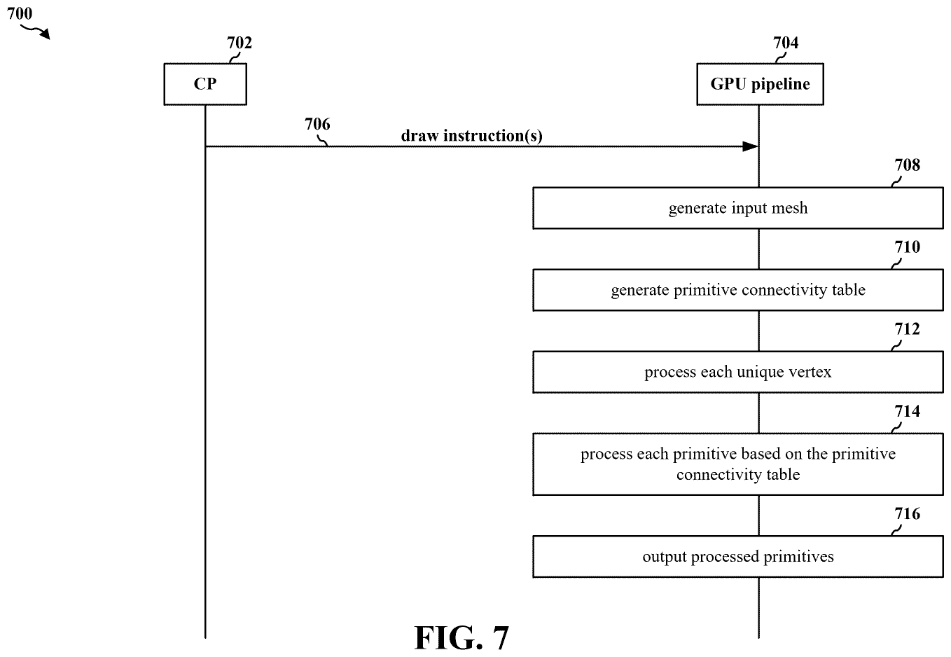

FIG. 7 is a call flow diagram 700 illustrating example communications between a CP 702 and a GPU pipeline 704 in accordance with one or more techniques of this disclosure. The CP 702 may output an indication 706 of a set of draw instructions to the GPU pipeline 704. The GPU pipeline 704 may obtain the indication 706 of the set of draw instructions from the CP 702.

At 708, the GPU pipeline 704 may generate an input mesh based on the indication 706 of the set of draw instructions. For example, an input assembler of the GPU pipeline 704 may generate an input mesh, such as the input mesh 600 in FIG. 6A, for a merged shader. The merged shader may obtain the generated input mesh from the input assembler.

At 710, the GPU pipeline 704 may generate a primitive connectivity table based on the input mesh. For example, a merged shader may obtain an indication of a set of memory addresses from the input assembler, and may then generate a primitive connectivity table based on the indication of the set of memory addresses and the corresponding input mesh. This primitive connectivity table may associate primaries with memory addresses of associated processed vertices of the merged shader.

At 712, the GPU pipeline 704 may process each unique vertex. The GPU pipeline may store each processed vertex in an on-chip memory, such as GMEM or device memory (DMEM). Each processed vertex may be associated with a unique memory address, which may be referenced by the primitive connectivity table generated at 710.

At 714, the GPU pipeline 704 may process each primitive based on the primitive connectivity table. For example, a merged shader may read processed vertices from the on-chip memory based on memory addresses in the primitive connectivity table. Each primitive processing thread may be synchronized with one or more vertex processing threads to ensure that the primitive processing thread reads the processed vertex after the corresponding vertex processing has completed.

At 716, the GPU pipeline 704 may output the processed primitives, for example to storage or to a display device.

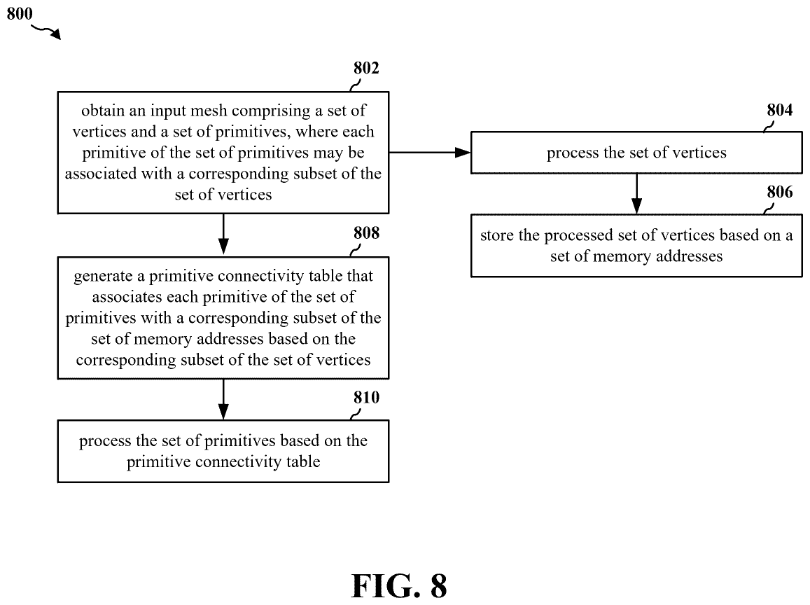

FIG. 8 is a flowchart 800 of an example method of graphics processing in accordance with one or more techniques of this disclosure. The method may be performed by an apparatus, such as an apparatus for graphics processing, a GPU, a CPU a wireless communication device, and the like, as used in connection with the aspects of FIGS. 1-5, 6A-6C, and 7.

At 802, the apparatus may obtain an input mesh. The input mesh may include a set of vertices and a set of primitives. Each primitive of the set of primitives may be associated with a corresponding subset of the set of vertices. For example, referring to FIG. 7, 802 may be performed by the GPU pipeline 704, which may obtain an input mesh from an input assembler. The input mesh may include a set of vertices and a set of primitives. Each primitive of the set of primitives may be associated with a corresponding subset of the set of vertices. The GPU pipeline 704 may leverage the input mesh to populate a primitive connectivity table, such as the primitive connectivity table 610 in FIG. 6B. Moreover, 802 may be performed by the merged shader pipeline 198 in FIG. 1.

At 804, the apparatus may process the set of vertices. For example, referring to FIG. 7, 804 may be performed by the GPU pipeline 704, which may perform geometry processing on the set of vertices. The GPU pipeline 704 may concurrently execute a set of vertex processing threads to process unique vertices. Moreover, 804 may be performed by the merged shader pipeline 198 in FIG. 1.

At 806, the apparatus may store the processed set of vertices based on a set of memory addresses. For example, referring to FIG. 7, 806 may be performed by the GPU pipeline 704, which may store the processed set of vertices to a set of memory addresses of an on-chip storage, such as the on-chip storage 628 of FIG. 6C. The GPU pipeline 704 may store the processed set of vertices based on a set of vertex offsets obtained from the input assembler. Moreover, 806 may be performed by the merged shader pipeline 198 in FIG. 1.

At 808, the apparatus may generate a primitive connectivity table that associates each primitive of the set of primitives with a corresponding subset of the set of memory addresses based on the corresponding subset of the set of vertices. For example, referring to FIG. 7, 808 may be performed by the GPU pipeline 704, which may populate a primitive connectivity table that associates each primitive of the set of primitives with a corresponding subset of the set of memory addresses based on the corresponding subset of the set of vertices. The GPU pipeline 704 may populate the primitive connectivity table based on the input mesh obtained at 802. Moreover, 808 may be performed by the merged shader pipeline 198 in FIG. 1.

At 810, the apparatus may process the set of primitives based on the primitive connectivity table. For example, referring to FIG. 7, 810 may be performed by the GPU pipeline 704, which may perform geometry processing on the set of primitives based on the primitive connectivity table. The GPU pipeline 704 may concurrently execute a set of primitive processing threads to process primitives based on the addresses associated with each unique vertex. The primitive processing threads may be synchronized with the vertex processing threads based on the primitive processing table, such that each primitive processing thread executes after the corresponding vertices are stored in the on-chip memory. The primitive processing threads may fetch data stored at the memory addresses of the on-chip memory, thereby avoiding reprocessing the same vertex multiple times where a plurality of primitives use the same vertex. Moreover, 810 may be performed by the merged shader pipeline 198 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware device within the device 104 or another device communicating with the device 104. The apparatus may include means for obtaining an input mesh. The input mush may include a set of vertices and a set of primitives. Each primitive of the set of primitives may be associated with a corresponding subset of the set of vertices. The apparatus may further include means for processing the set of vertices. The apparatus may further include means for storing the processed set of vertices based on a set of memory addresses. The apparatus may further include means for generating a primitive connectivity table that associates each primitive of the set of primitives with a corresponding subset of the set of memory addresses based on the corresponding subset of the set of vertices. The apparatus may further include means for processing the set of primitives based on the primitive connectivity table. The apparatus may further include means for storing the processed set of primitives to memory; or outputting the processed set of primitives. The apparatus may further include means for processing the set of vertices and processing the set of primitives by processing the set of vertices and the set of primitives via a merged geometry processing shader. The merged geometry processing shader may include a merged VS and HS. The merged geometry processing shader may include a merged DS and GS. The apparatus may further include means for processing the set of vertices by refraining from processing any vertex of the set of vertices twice by leveraging a primitive connectivity table. The apparatus may further include means for refraining from processing any vertex of the set of vertices twice by refraining from processing any vertex of the set of vertices twice based on a vertex reuse cache in an input assembler stage. The apparatus may further include means for obtaining the input mesh comprises: obtaining the input mesh from an input assembler stage. The apparatus may further include means for obtaining a set of vertex offsets from the input assembler stage. The apparatus may further include means for determining the set of memory addresses based on the obtained set of vertex offsets. The apparatus may further include means for processing the set of vertices by (a) distributing a plurality of subsets of the set of vertices among a plurality of threads and (b) parallelly executing a plurality of vertex processing threads. No subset of the plurality of subsets of the set of vertices may overlap with one another. Each vertex processing thread of the plurality of vertex processing threads may process a subset of the plurality of subsets of the set of vertices. The apparatus may further include means for processing the set of primitives by (a) distributing a plurality of subsets of the set of primitives among a plurality of threads, and (b) parallelly executing a plurality of primitive processing threads. No subset of the plurality of subsets of the set of primitives may overlap with one another. Each primitive processing thread of the plurality of primitive processing threads may process a subset of the plurality of subsets of the set of primitives. The apparatus may further include means for synchronizing each primitive processing thread with a subset of the plurality of vertex processing threads based on the primitive connectivity table. The means may include the merged shader pipeline 198 in FIG. 1.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

An indication of a set of data may include the data itself, or a reference to the data, for example a memory address where the data may be retrieved by the receiving entity, or an index to a set of data (e.g., an index of 1 that represents the series of bits 1100101). A single indication may also include a set of indications, for example an array of memory addresses or a plurality of index references.

The following aspects are illustrative only and may be combined with other aspects or teachings described herein, without limitation.
Aspect 1 is a method of graphics processing, comprising: obtaining an input mesh comprising a set of vertices and a set of primitives, wherein each primitive of the set of primitives is associated with a corresponding subset of the set of vertices; processing the set of vertices; storing the processed set of vertices based on a set of memory addresses; generating a primitive connectivity table that associates each primitive of the set of primitives with a corresponding subset of the set of memory addresses based on the corresponding subset of the set of vertices; and processing the set of primitives based on the primitive connectivity table.
Aspect 2 is the method of aspect 1, further comprising: storing the processed set of primitives to memory; or outputting the processed set of primitives.
Aspect 3 is the method of either aspect 1 or 2, wherein processing the set of vertices and processing the set of primitives comprises: processing the set of vertices and the set of primitives via a merged geometry processing shader.
Aspect 4 is the method of aspect 3, wherein the merged geometry processing shader comprises at least one of: a merged vertex shader (VS) and hull shader (HS); or a merged domain shader (DS) and geometry shader (GS).
Aspect 5 is the method of any of aspects 1 to 4, wherein processing the set of vertices comprises: refraining from processing any vertex of the set of vertices twice.
Aspect 6 is the method of aspect 5, wherein refraining from processing any vertex of the set of vertices twice comprises: refraining from processing any vertex of the set of vertices twice based on a vertex reuse cache in an input assembler stage.
Aspect 7 is the method of any of aspects 1 to 6, wherein obtaining the input mesh comprises: obtaining the input mesh from an input assembler stage.
Aspect 8 is the method of aspect 7, further comprising: obtaining a set of vertex offsets from the input assembler stage; and determining the set of memory addresses based on the obtained set of vertex offsets.
Aspect 9 is the method of any of aspects 1 to 8, wherein processing the set of vertices comprises: distributing a plurality of subsets of the set of vertices among a plurality of threads, wherein no subset of the plurality of subsets of the set of vertices overlap with one another; and parallelly executing a plurality of vertex processing threads, wherein each vertex processing thread of the plurality of vertex processing threads processes a subset of the plurality of subsets of the set of vertices.
Aspect 10 is the method of aspect 9, wherein processing the set of primitives comprises: distributing a plurality of subsets of the set of primitives among a plurality of threads, wherein no subset of the plurality of subsets of the set of primitives overlap with one another; and parallelly executing a plurality of primitive processing threads, wherein each primitive processing thread of the plurality of primitive processing threads processes a subset of the plurality of subsets of the set of primitives.
Aspect 11 is the method of aspect 10, further comprising: synchronizing each primitive processing thread with a subset of the plurality of vertex processing threads based on the primitive connectivity table.
Aspect 12 is an apparatus for graphics processing including at least one processor coupled to a memory and configured to implement a method as in any of aspects 1-11.
Aspect 13 may be combined with aspect 12 and includes that the apparatus is a wireless communication device.
Aspect 14 is an apparatus for graphics processing including means for implementing a method as in any of aspects 1-11.
Aspect 15 is a computer-readable medium (e.g., a non-transitory computer-readable medium) storing computer executable code, the code when executed by at least one processor causes the at least one processor to implement a method as in any of aspects 1-11.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
obtain an input mesh comprising a set of vertices and a set of primitives, wherein each primitive of the set of primitives is associated with a corresponding subset of the set of vertices;
process the set of vertices;
store the processed set of vertices based on a set of memory addresses;
generate a primitive connectivity table that associates each primitive of the set of primitives with a corresponding subset of the set of memory addresses based on the corresponding subset of the set of vertices; and
process the set of primitives based on the primitive connectivity table.

2. The apparatus of claim 1, wherein the processor is further configured to:
store the processed set of primitives to the memory; or output the processed set of primitives.

3. The apparatus of claim 1, wherein, to process the set of vertices and process the set of primitives, the processor is configured to:
process the set of vertices and the set of primitives via a merged geometry processing shader.

4. The apparatus of claim 3, wherein the merged geometry processing shader comprises at least one of:
a merged vertex shader (VS) and hull shader (HS); or
a merged domain shader (DS) and geometry shader (GS).

5. The apparatus of claim 1, wherein, to process the set of vertices, the processor is configured to:
refrain from processing any vertex of the set of vertices twice.

6. The apparatus of claim 5, wherein, to refrain from processing any vertex of the set of vertices twice, the processor is configured to:
refrain from processing any vertex of the set of vertices twice based on a vertex reuse cache in an input assembler.

7. The apparatus of claim 1, wherein, to obtain the input mesh, the processor is configured to:
obtain the input mesh from an input assembler.

8. The apparatus of claim 7, wherein the processor is further configured to:
obtain a set of vertex offsets from the input assembler; and
determine the set of memory addresses based on the obtained set of vertex offsets.

9. The apparatus of claim 1, wherein, to process the set of vertices, the processor is configured to:
distribute a plurality of subsets of the set of vertices among a plurality of threads, wherein no subset of the plurality of subsets of the set of vertices overlap with one another; and
parallelly execute a plurality of vertex processing threads, wherein each vertex processing thread of the plurality of vertex processing threads processes a subset of the plurality of subsets of the set of vertices.

10. The apparatus of claim 9, wherein, to process the set of primitives, the processor is configured to:
distribute a plurality of subsets of the set of primitives among a plurality of threads, wherein no subset of the plurality of subsets of the set of primitives overlap with one another; and
parallelly execute a plurality of primitive processing threads, wherein each primitive processing thread of the plurality of primitive processing threads processes a subset of the plurality of subsets of the set of primitives.

11. The apparatus of claim 10, wherein the processor is further configured to:
synchronize each primitive processing thread with a subset of the plurality of vertex processing threads based on the primitive connectivity table.

12. The apparatus of claim 1, wherein the apparatus comprises a wireless communication device.

13. A method of graphics processing, comprising:
obtaining an input mesh comprising a set of vertices and a set of primitives, wherein each primitive of the set of primitives is associated with a corresponding subset of the set of vertices;
processing the set of vertices;
storing the processed set of vertices based on a set of memory addresses;
generating a primitive connectivity table that associates each primitive of the set of primitives with a corresponding subset of the set of memory addresses based on the corresponding subset of the set of vertices; and
processing the set of primitives based on the primitive connectivity table.

14. The method of claim 13, wherein processing the set of vertices and processing the set of primitives comprises:
processing the set of vertices and the set of primitives via a merged geometry processing shader.

15. The method of claim 13, wherein processing the set of vertices comprises:
refraining from processing any vertex of the set of vertices twice based on a vertex reuse cache in an input assembler stage.

16. The method of claim 13, wherein obtaining the input mesh comprises:
obtaining the input mesh from an input assembler stage;
obtaining a set of vertex offsets from the input assembler stage; and
determining the set of memory addresses based on the obtained set of vertex offsets.

17. The method of claim 13, wherein processing the set of vertices comprises:
distributing a plurality of subsets of the set of vertices among a plurality of threads, wherein no subset of the plurality of subsets of the set of vertices overlap with one another; and
parallelly executing a plurality of vertex processing threads, wherein each vertex processing thread of the plurality of vertex processing threads processes a subset of the plurality of subsets of the set of vertices.

18. The method of claim 17, wherein processing the set of primitives comprises:
distributing a plurality of subsets of the set of primitives among a plurality of threads, wherein no subset of the plurality of subsets of the set of primitives overlap with one another; and
parallelly executing a plurality of primitive processing threads, wherein each primitive processing thread of the plurality of primitive processing threads processes a subset of the plurality of subsets of the set of primitives.

19. The method of claim 18, further comprising:
synchronizing each primitive processing thread with a subset of the plurality of vertex processing threads based on the primitive connectivity table.

20. A computer-readable medium storing computer executable code, the code when executed by a processor, causes the processor to:
obtain an input mesh comprising a set of vertices and a set of primitives, wherein each primitive of the set of primitives is associated with a corresponding subset of the set of vertices;
process the set of vertices;
store the processed set of vertices based on a set of memory addresses;
generate a primitive connectivity table that associates each primitive of the set of primitives with a corresponding subset of the set of memory addresses based on the corresponding subset of the set of vertices; and
process the set of primitives based on the primitive connectivity table.
